(19) United States
(12) Patent Application Publication
(10) Pub. No.: US 2023/0019302 A1
(43) Pub. Date: Jan. 19, 2023

(54) WAGERING METHODS FOR SKILL BASED GAMES

(71) Applicant: IGT, Las Vegas, NV (US)

(72) Inventor: Garrett Fleischer, Rincon, PR (US)

(73) Assignee: IGT

(21) Appl. No.: 17/375,113

(22) Filed: Jul. 14, 2021

(51) Int. Cl. A63F 3/02

(52) U.S. Cl. CPC A63F 3/022

(57) ABSTRACT

A gaming system, computer-implemented method and gaming device are provided. A gaming system includes a processor circuit, a memory coupled to the processor circuit. The memory includes machine-readable instructions that cause the processor circuit to receive multiple wagers from multiple players of a skill-based game, determine a net award amount that is a sum of the wagers minus a casino fee, analyze game performance of each of the players to determine optimality values corresponding to skill levels of each of the players, display the optimality values on the display device during the skill-based game, determine portions of the net award amount to award to the players based on an outcome of the skill-based game and the optimality values, and award the portions of the net award amount to respective ones of the players.

### BACKGROUND

Embodiments described herein relate to providing opportunities for skill-based game wagering. Skill-based gaming may include in-person games in which players meet at a gaming location, such as a casino, and/or virtual rooms in which the players may interface with one another remotely. Skill-based events may have many aspects that make them attractive to spectators, both from an entertainment standpoint and a wagering and/or betting standpoint. As technology improves and as the competition for the attention of players and/or spectators increases, there is a need for additional features that increase player attraction to skill-based gaming.

### SUMMARY

According to some embodiments, a gaming system includes a processor circuit and a memory coupled to the processor circuit. The memory includes machine-readable instructions that, when executed by the processor circuit, cause the processor circuit to receive multiple wagers from multiple skill-based game players to play a skill-based game against one another, determine a net award amount that is based on the wagers, wherein the net award amount is awarded to the skill-based game players, and, after the skill-based game is complete, analyze game performance of the skill-based game players to determine optimality values corresponding to the skill-based game players. The processor circuit further, based on the optimality values and an outcome of the skill-based game, determines portions of the net award amount to be awarded to the skill-based game players.

Some embodiments are directed to a computer-implemented method of operating a gaming device. Operations according to such methods include receiving a first wager from a first player of a skill-based game and a second wager from a second player of the skill-based game, wherein the skill-based game includes the first player playing against the second player. Operations include determining a net award amount as a sum of the first wager and the second wager minus a casino fee, storing game action data corresponding to multiple game actions by the first player and the second player taken during play of the skill-based game, analyzing, based on the game action data, game performance of each of the first player and the second player and determining, based on the analyzing, a first optimality value that represents a skill level of the first player and a second optimality value that represents a skill level of the second player. Operations include, based on the outcome of the skill-based game, the first optimality value and the second optimality value, awarding a first portion of the net award amount to the first player and a second portion of the net award amount to be awarded to the second player.

Some embodiments are directed to a gaming device that includes a display device, a processor circuit, and a memory coupled to the processor circuit. The memory includes machine-readable instructions that, when executed by the processor circuit, cause the processor circuit to receive multiple wagers from a multiple players of a skill-based game, wherein the skill-based game provides that the players are playing against each other. The processor circuit is further caused to determine a net award amount that is a sum of the wagers minus a casino fee, analyze game performance of each of the players to determine multiple optimality values corresponding to skill levels of each of the players, display the optimality values on the display device during the skill-based game, determine multiple portions of the net award amount to award to the players based on an outcome of the skill-based game and the optimality values, and award the portions of the net award amount to respective ones of the players.

### BRIEF DESCRIPTION OF THE DRAWINGS

FIG. 1 is a schematic block diagram that illustrates a system including a plurality of skill-based gaming devices according to some embodiments.

FIG. 2 is schematic block diagram illustrating network configurations for a system including a skill-based game content server according to some embodiments.

FIG. 3 is a schematic block diagram illustrating a dedicated skill-based gaming terminal 300 for providing skill-based gaming according to some embodiments.

FIGS. 4A-4C are partial schematic block diagrams illustrating a skill-based gaming device according to some embodiments.

FIG. 5 is a flowchart illustrating operations of systems/methods according to some embodiments.

FIG. 6 is a block diagram that illustrates various components of a computing device 1500, which may embody or be included as part of the devices, systems, and/or components above, according to some embodiments.

### DETAILED DESCRIPTION

Embodiments herein are directed to various systems, devices and methods for providing wagering methods for skill-based games. Specifically, embodiments herein provide a user interface that is a technical solution that addresses the problem corresponding to wagering in skill-based games.

Embodiments disclosed herein may be performed using a gaming device to wager in skill-based gaming. As used herein, a gaming device may include mobile devices, personal computers, kiosks and/or sports betting terminals, among others. The user can wager real money, virtual money and/or points.

Some embodiments provide that in games of “perfect knowledge” where both players know the full state of the game, it is possible to calculate how optimally a player makes game play decisions. The optimality calculation may be used in a skill-based wagering approach as disclosed herein. In some embodiments, such approaches may be used on a per-game basis without any data that is external to the skill-based game. In this manner, embodiments herein may be performed without an external storage and/or retrieval operation of data. Such embodiments may provide significant advantages over similar systems such as previously performed score calculations that may rely on multiple games worth of data.

In some embodiments, when a skill-based game begins, each of the multiple players may place their bets. After bets from all of the players are received, a skill-based game provider may retain a portion of the sum of the received bets. In a non-limiting example, the skill-based game provider may be a casino and the casino may retain a portion of the sum of the received bets as a fee for providing the skill-based game. For example, a casino may retain 10% of the sum of received bets, leaving 90% of the sum of received bets as an award that may be a net award amount to be divided among the players.

Some embodiments provide that when the game is complete, the moves or game actions of all players are analyzed to determine skill-based game play optimality values. Based on this analysis, each of the players may have a percentage score is assigned to them. For example, in some embodiments, an optimality value (optimality %) may be determined for each player.

In some embodiments, the winner of the skill-based game may be awarded takes a percentage of the net award amount based on a formula that includes the optimality values:

Winning award=Max(50%,[100%−Max(0,[<Optimality % Winner>−<Optimality % Loser(s)>])]), in which

Optimality % Winner is the optimality value calculated in the skill-based game corresponding to the winner and Optimality % Loser(s) is the optimality value calculated in the skill-based game corresponding to the loser(s).

In the context of a two person skill-based game, such as chess, the remaining portion of the net award amount may be awarded to the loser(s) of the skill-based game. In some embodiments, a skill-based game may include more than two players and thus may have more than one non-winning player. In such cases, the above formula may be applied by using the highest performing non-winning player's optimality value relative to the winning player's optimality value to determine the winning player's portion of the net award amount and then using the optimality values of the highest and the next highest optimality values to determine to determine the highest non-winning player's portion of the net award amount. Some embodiments provide that such operations may be repeated to determine all of the non-winning players' portions of the remaining net award amount.

Some embodiments provide that the above formula may be particularly applicable in the case of a clear winner of the skill-based game. For example, a stalemate/draw may result in a splitting of the net award amount among the players.

In some embodiments, the minimum amount a winning player can take is 50% of the net award amount.

In some embodiments, if the winning player was less skilled than their opponent, the winning player may be awarded up to 100% of the net award amount.

Some embodiments provide that to reduce opportunities to manipulate the outcomes, the moves or game actions taken by each player may be weighted based on recency. For example, game actions taken later in a game may be weighted more heavily than those taken earlier in the game. In this manner, later moves may contribute more to the optimality values than earlier ones. In some embodiments, the weighting of game actions may be randomized and or may be calculated using values corresponding to moving averages of the game actions. In this manner, it may be more difficult for a player to play optimally early on, then play poorly later and still win the game.

By using the optimality values, fair play may be encouraged by providing a monetary advantage to those of lesser or equal skill relative to their opponents. For example, it may not be to a player's advantage to pay the casino fees while taking advantage of less experienced players.

Some embodiments provide that other benefits include that there is no need to access a database and/or a past history of games. Some other embodiments may provide that data corresponding to historical game performance may enhance approaches disclosed herein. Embodiments herein may benefit casinos because the casino fees are provided entirely by the players and the casino receives fees corresponding to every skill-based game regardless of the outcome.

In games of “perfect knowledge” such as chess where both players know the full state of the game, it is possible to calculate how optimally players make their decisions. Some embodiments provide that in games of “imperfect knowledge” such as Poker, where only a subset of the game state is known to each player, it may be more difficult to quantify optimality when ono-quantitative actions such as player behavior and bluffing.

In some embodiments, the optimality calculation can be used as factor in providing unique wagering opportunities in skill-based games where the optimality values can be calculated. For example, in a game of Chess, both players sit down and place their bets. The casino may take a fee that may be a fixed fee and/or a percentage of the sum of wagers received. The remainder is the net award amount, which is available to the players after the skill-based game has ended.

When the game is complete, the game actions of both players are analyzed for optimality and a percentage score is assigned to each of the players (optimality %). The winner of the game takes a percentage of the net award amount based on the formula provided above equivalent to the following formula and the loser takes the remainder. A stalemate/draw results in a split net award amount or the net award amount may be divided based on the difference in the optimality values corresponding to each player. Some embodiments provide the latter option may benefit weaker players if they manage to end the game in a draw vs a skilled opponent, however it may also present another opportunity for players to “game” the system.

Some embodiments provide that the minimum amount a winning player can take is 50% of the net award amount. In such cases, the winning player still pays their portion of the casino fee. Some embodiments provide that in the case where the winning player is less skilled than the losing player, the winning player is limited to 100% of the net award amount.

The optimality difference calculation ensures that a winning player that plays against one of equivalent or greater skill will be awarded a large percentage of the net award amount whereas a winning player of advanced skill vs a player of minimal skill will be awarded a smaller percentage of the net award amount. Thus, it may not be in their interest to pay casino fees by playing against significantly weaker opponents.

In the case where a player tries to take advantage of the system by playing poorly early on then making optimal game actions later, the moves can be weighted based on when in the game they are made. For example, later game actions may contribute more to the optimality value than earlier ones. In this manner, it may be difficult to play optimally early on, then play poorly later and still win the game.

Embodiments herein may be further advantageous over systems that score calculations and that require players to play multiple games and have an account tied to their identity. For example, some embodiments provide that the optimality value may be calculated on a per-game basis without any outside information that needs to be stored or retrieved.

In some embodiments, a database or other data repository may be provided to maintain and/or provide historical optimality data. In some embodiments, players may log in, scan their fingerprint or provide other input, biometric or otherwise, to be entered into the system. Once logged in, the player's average optimality score may be publicly displayed on a display device corresponding to systems and devices disclosed herein. The average score may be factored into the score for the current game, but it does not have to be. In some embodiments, further data may include skill-based game performance data, including, for example, historical and/or average earnings. Some embodiments provide that earning data may be hidden from public view unless the player chooses to show it.

In some embodiments, the average optimality score over all games played may be weighted more heavily towards recent games and/or based on the size of the stakes. In this manner, a player may not artificially give himself a lower score in small stakes games then use the artificially generated lower score to their advantage in a higher stake game. In this manner, fair play may be encouraged by giving a monetary advantage to those of lesser skill relative to the skill of their opponents.

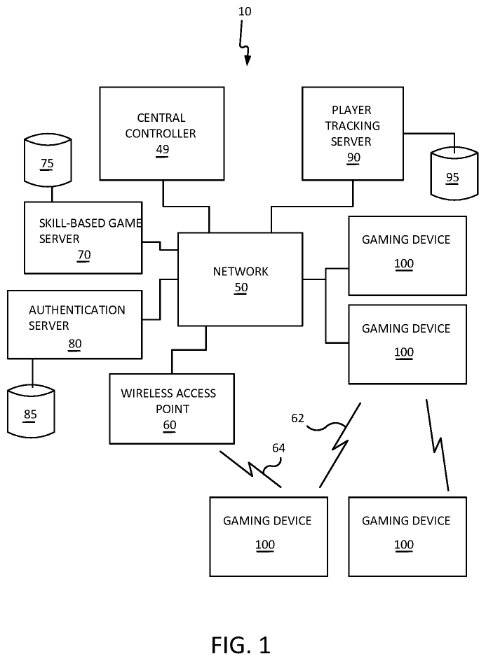

In this regard, reference is now made to FIG. 1, which illustrates schematic block diagram of a system 10 including a plurality of skill-based gaming devices 100 according to some embodiments. The system 10 may be located, for example, on the premises of a gaming establishment, such as a casino, in a private residence, or may include components that are located at different locations. The skill-based gaming devices 100 may be in communication with each other and/or a central controller 49 through a data communication network 50, or remote communication link. The data communication network 50 may be a private data communication network that is operated, for example, by the gaming facility that operates the skill-based gaming device 100, a publicly accessible data communication network such as the Internet, or a combination thereof. Communications over the data communication network 50 may be encrypted for security. The central controller 40 may be any suitable server or computing device which includes at least one processing circuit, such as a processor, and at least one memory or storage device. Each skill-based gaming device 100 may include a processing circuit that transmits and receives events, messages, commands or any other suitable data or signal between the skill-based gaming device 100 and the central controller 49 and/or other skill-based gaming devices 100. The gaming device processor is operable to execute such communicated events, messages or commands in conjunction with the operation of the skill-based gaming device 100. Moreover, the processor of the central controller 49 is configured to transmit and receive events, messages, commands or any other suitable data or signal between the central controller 49 and each of the individual skill-based gaming devices 100. In some embodiments, one or more of the functions of the central controller 49 may be performed by one or more gaming device processors. Moreover, in some embodiments, one or more of the functions of one or more gaming device processors as disclosed herein may be performed by the central controller 49.

A wireless access point 60 provides wireless access to the data communication network 50. The wireless access point 60 may be connected to the data communication network 50 as illustrated in FIG. 1, or may be connected directly to the central controller 49 or another server connected to the data communication network 50.

One or more content servers, such as a skill-based game server 70, may also be connected through the data communication network 50. The skill-based game server 70 may manage delivery of skill-based game content to a user of a skill-based gaming device 100. The skill-based game content may be stored in a skill-based game content database 75. The skill-based gaming content may be stored in a skill-based gaming content database 75. The skill-based game server 70 may be implemented within or separately from the central controller 40.

An authentication server 80 may receive an authentication input corresponding to a skill-based game player. A database 85 may be configured to store optimality data corresponding a plurality of players. In response to receiving the authentication input, the database 85 may generate optimality information corresponding to the skill-based game player. Optimality data may include statistical data such as averages, ranges, medians and/or raw data among others. In some embodiments, the optimality information may be displayed during the skill-based game.

A player tracking server 90 may also be connected through the data communication network 50. The player tracking server 90 may manage a player tracking account that tracks the gameplay and spending and/or other player preferences and customizations of a player, i.e., the user of the skill-based gaming device 100, manages loyalty awards for the player, manages funds deposited or advanced on behalf of the player, and other functions. Player information managed by the player tracking server 90 may be stored in a player information database 95.

The skill-based gaming devices 100 communicate with one or more elements of the system 10 to coordinate providing skill-based gaming. For example, in some embodiments, a skill-based gaming device 100 may communicate directly with another skill-based gaming device 100 over a wireless interface 62, which may be a WiFi link, a Bluetooth link, an NFC link, etc. In other embodiments, the skill-based gaming device 100 may communicate with the data communication network 50 (and devices connected thereto, including EGMs) over a wireless interface 64 with the wireless access point 160. The wireless interface 64 may include a WiFi link, a Bluetooth link, an NFC link, etc. In still further embodiments, the skill-based gaming device 100 may communicate with other skill-based gaming devices 100 or other devices over the wireless interface 62 and the wireless access point 60 over the wireless interface 64. In these embodiments, the wireless interface 62 and the wireless interface 64 may use different communication protocols and/or different communication resources, such as different frequencies, time slots, spreading codes, etc. For example, in some embodiments, the wireless interface 62 may be a Bluetooth link, while the wireless interface 64 may be a WiFi link.

The wireless interfaces 62, 64 allow the skill-based gaming devices 100 and/or central controller 40 to coordinate providing skill-based game content to the skill-based gaming devices 100.

In some embodiments, the central controller 40 and/or the skill-based game server 70 and/or gaming content server 80 may coordinate the generation and display of the skill-based gaming content to more than one user and/or to more than one skill-based gaming device 100. As described in more detail below, this may enable multiple users to interact with the skill-based gaming content in real time. This feature can be used to provide a shared multiplayer experience to multiple users at the same time. Moreover, in some embodiments, the central controller 40, skill-based game server 70 may coordinate the generation and display of the streaming video content and the synchronized gaming content to users at different physical locations.

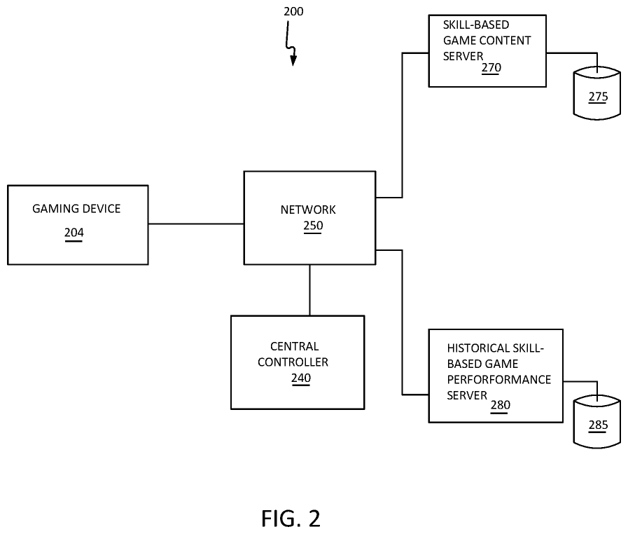

Referring now to FIG. 2, a schematic block diagram illustrating network configurations for a system 200 including a skill-based game content server 270 and a gaming historical skill-based game performance server 280 is illustrated. The system 200 may include a skill-based gaming device 204 and a central controller 240 for providing skill-based gaming content a user via the skill-based gaming device 204. In this example, the skill-based gaming device 204 is connected to the central controller 240 via a network 250, but it should be understood that the central controller 240 in some embodiments may be part of the skill-based gaming device 204 or may be connected to the skill-based gaming device 204 via a direct wired or wireless connection as well. A skill-based game content server 270 and a historical skill-based game performance server 280 are also connected to the central controller 240 via the network 250 in this example.

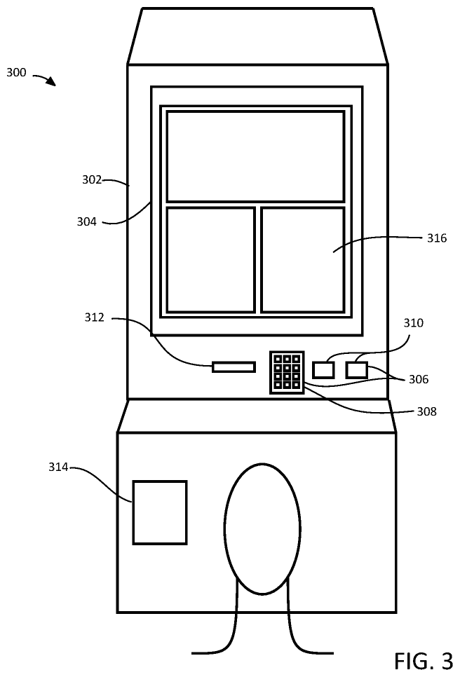

As used herein, a skill-based gaming device may include, for example, an electronic gaming device such as an electronic gaming machine (EGM), gaming terminal, etc., an electromechanical gaming device, a computing device such as a personal computer, a mobile computing device such as a tablet, smartphone, etc., or another device or devices. For example, reference is now made to FIG. 3, which is a schematic block diagram illustrating a dedicated skill-based gaming terminal 300 for providing skill-based gaming according to some embodiments. In some embodiments, the skill-based gaming terminal 300 includes a housing 302 having a display device 304, and a plurality of input devices 306, such as a keypad 308, buttons 310, etc., for receiving user input for playing the skill-based game and otherwise interacting with the skill-based gaming terminal 300. In some embodiments, the display device 304 may include a touchscreen interface for receiving user input as well. The display device 304 may also be a single display device or may include multiple display devices, such as a first display device for displaying skill-based gaming content and a second display device for displaying gaming and wagering information including, for example, optimality value information. The skill-based gaming terminal 300 may include additional specialized hardware as well, such as an acceptor 312, for receiving currency (i.e., bills and/or coins), tokens, credit or debit cards, or other physical items associated with monetary or other value. The skill-based gaming terminal 300 may also include a dispenser 314, for dispensing items, such as physical items having monetary or other value (e.g., awards or prizes) or other items.

As will be discussed in detail below, the skill-based gaming terminal 300 may include a processor circuit and a memory coupled to the processor circuit. The memory may include machine-readable instructions that, when executed by the processor circuit, cause the processor circuit to perform operations for operating the gaming terminal 300 and/or other features described herein. In this example, the gaming terminal 300 may include a graphical user interface (GUI) 316 displayed by the display device 304 for providing the video and gaming information to the player.

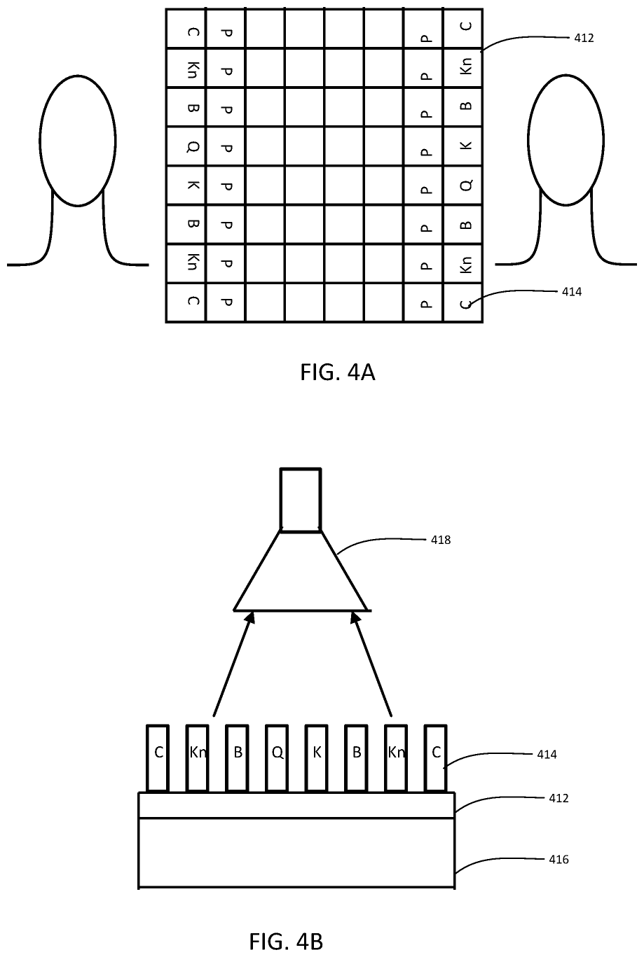

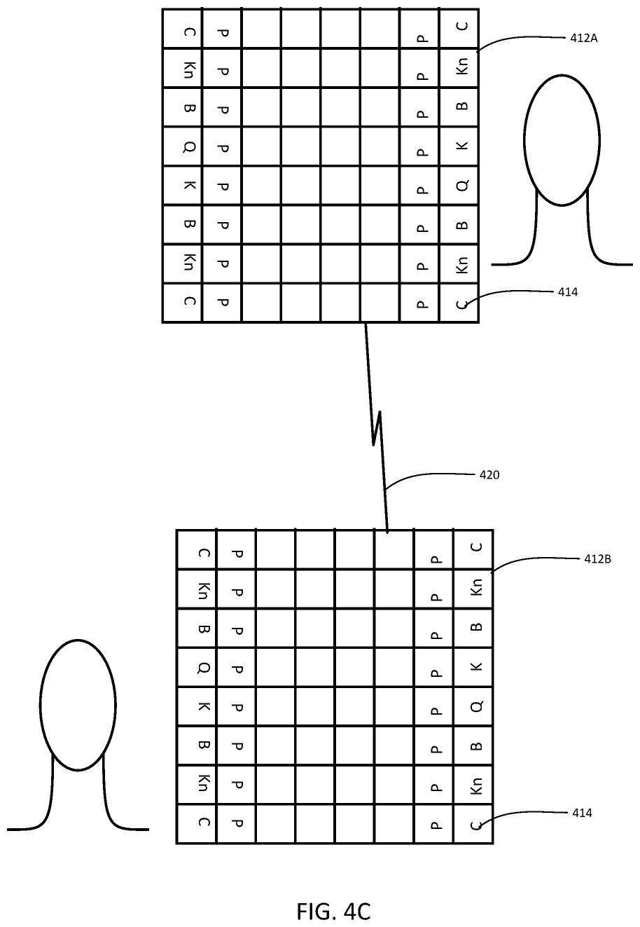

Brief reference is now made to FIGS. 4A-4C, which are partial schematic block diagrams illustrating a skill-based gaming device according to some embodiments. Referring to FIG. 4A, a skill-based gaming device may include a physical game board 412 that is configured to provide a surface on which the skill-based game may be played. Some embodiments provide that skill-based game play may be performed by moving different ones of a plurality of physical game pieces 414 on the physical game board 412. For example, embodiments corresponding to the skill-based game of chess are illustrated in FIGS. 4A-4C. Based on the outcome of the game and the moves made by each player during the game, portions of the net award amount may be determined and the portions may be paid to the players. Determining the net award amount portions may be performed based on calculating an optimality score corresponding to each player of the skill-based game.

Referring to FIG. 4B, each move of the physical game pieces 414 on the physical game board 412 may be determined and recorded by each of the players. For example, some embodiments of the skill-based gaming device include position sensors 416 that are configured to determine and store each move of each of the plurality of skill-based game players. Some embodiments provide that the skill-based gaming device includes an image capture device 418 that is configured to determine and store each move of the plurality of skill-based game players. Some embodiments may include the position sensors 416 and/or the image capture device 418.

Briefly referring to FIG. 4C, some embodiments provide that the skill-based gaming device includes multiple physical game boards 412A, 412B that permit the players to play remote from one another using a wired and/or wireless data communication interface 420. In some embodiments, a first player may play the skill-based game using a physical game board with physical game pieces while a second player of the same skill-based game may play using a graphical user interface that does not include a physical game board or physical game pieces.

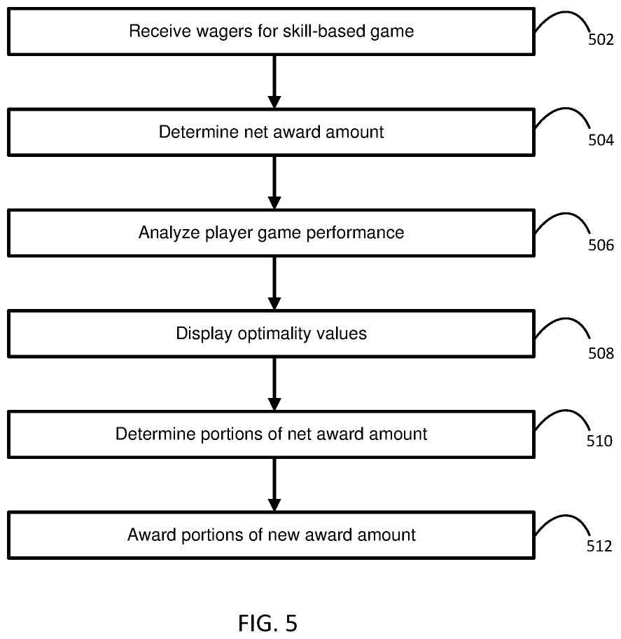

These and other features may be implemented as operations that may be executed by a processor circuit of a computing device. Reference is now made to FIG. 5, which is a flowchart illustrating operations of systems/methods according to some embodiments. For example, a gaming system may include a processor circuit and a memory coupled to the processor circuit. The memory includes machine-readable instructions that, when executed by the processor circuit, cause the processor circuit to perform certain operations. For example, the processor may be caused to receive (block 502) multiple wagers from multiple skill-based game players to play a skill-based game against one another. Some embodiments provide that the skill-based game is between two players while other embodiments provide that the skill-based game is between more than two players and/or two or more teams of players.

The processor circuit is caused to determine (block 504) a net award amount that is based on the wagers that are received. For example, the net award amount may be determined by subtracting a percentage of the total sum of received wagers and/or by subtracting a fixed sum for each skill-based game. The amount subtracted from the total of the received wagers is paid to a skill-based game provider, such as a casino, among others. The net award amount that remains after the casino fee is subtracted is awarded to the plurality of skill-based game players.

After the skill-based game is complete, the processor circuit is caused to analyze (block 506) game performance of the skill-based game players to determine optimality values corresponding to the skill-based game players. For example, based on the performance of each player in the skill-based game, an optimality value may be generated for each player. In some embodiments, the optimality scores may be expressed as a percentage ranging from zero percent to 100 percent. In some embodiments, the optimality values may be displayed (block 508). Displaying the optimality scores may provide relative skill levels to an opponent or potential opponent and to any spectators. In circumstances in which optimality scores may be generated based on historical data, such scores may be used by spectators and or a casino to set odds and make wagers corresponding to the outcome of the skill-based game.

Based on the optimality values and also based on the outcome of the skill-based game, the processor circuit determines (block 510) portions of the net award amount to be awarded to the plurality of skill-based game players.

In some embodiments, the skill-based game is a two player game and the skill-based game players include a first player and a second player. In an example in may be determined that the first player has won the skill-based game and the second player has lost the skill-based game. The portions of the net award amount include a first percentage of the net award amount for the first player and a second percentage of the net award amount for the second player. Some embodiments provide that the first percentage is calculated, and the remainder of the net award amount is the second percentage.

Continuing with the example, in response to the second optimality value corresponding to the second player being greater than the first optimality corresponding to the first player, the first portion of the net award amount is 100 percent. In this manner, the lower scored player that prevails over the player with a higher skill level is rewarded the entire net award amount. Some embodiments provide that a minimum of the first percentage of the net award amount is 50 percent based on the first player winning the skill-based game.

In some embodiments, the first percentage of the net award amount is determined based on a formula:

Max(50%,(100%−Max(0,(first optimality value−second optimality value))).

Some embodiments provide that, responsive to a draw result in which none of the first skill-based game player or the second skill-based game player is determined to win, the first percentage of the net award amount and the second percentage of the net award amount are equal.

In some embodiments, responsive to a draw result in which none of the first skill-based game player or the second skill-based game player is determined to win, the first percentage of the net award amount and the second percentage of the net award amount are based on a difference between the first optimality value the second optimality value.

Some embodiments provide that the net award amount is determined based on determining a sum of the wagers and subtracting a casino fee from the sum of the wagers.

Some embodiments provide that the game is a perfect knowledge game in which each of the plurality of players know a full state of the game. Examples include chess and other games in which all information is known. In some embodiments, the game includes an imperfect knowledge game in which each of the players knows less than a full state of the game. Examples of such games include poker and other games in which the players only have a portion of the available knowledge about the game.

Some embodiments provide determining the optimality values is performed based exclusively on player performance in the skill-based game. In some embodiments, player performance includes game actions taken during play of the skill-based game and determining the optimality values is performed based on weighting game actions that are recent at a higher value than game actions that occurred prior to recent game actions. Some embodiments provide that determining the optimality values is performed based on game performance that occurred in skill-based games that previously occurred relative to the skill-based game.

Some embodiments include a database that is configured to store optimality data corresponding to the skill-based game players and an authentication interface that is configured to receive an authentication input corresponding to one of the skill-based game players. In some embodiments, in response to the receiving the authenticating input, the database generates an average optimality value corresponding to the one of the skill-based game players and the processor is configured to cause the average optimality value to be displayed on a display.

The processor circuit may further award (block 512) the portions of the new award amount to the players. In some embodiments, the award may be provided in a cash equivalent form, game credits, and/or bonus credits among others.

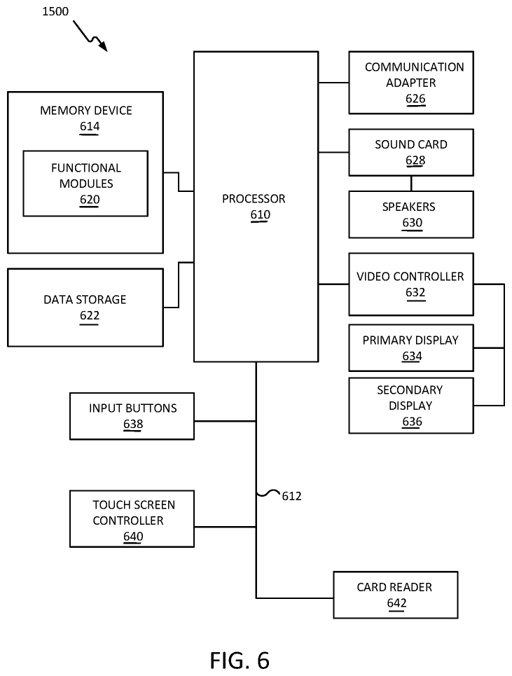

Referring now to FIG. 6, a block diagram that illustrates various components of a computing device 1500, which may embody or be included as part of the devices, systems, and/or components above, according to some embodiments. As shown in FIG. 6, the computing device 1500 may include a processor circuit 610 that controls operations of the computing device 1500. Although illustrated as a single processor, multiple special purpose and/or general-purpose processors and/or processor cores may be provided in the computing device 1500. For example, the computing device 1500 may include one or more of a video processor, a signal processor, a sound processor and/or a communication controller that performs one or more control functions within the computing device 1500. The processor circuit 610 may be variously referred to as a “controller,” “microcontroller,” “microprocessor” or simply a “computer.” The processor circuit 610 may further include one or more application-specific integrated circuits (ASICs).

Various components of the computing device 1500 are illustrated in FIG. 6 as being connected to the processor circuit 610. It will be appreciated that the components may be connected to the processor circuit 610 and/or each other through one or more busses 612 including a system bus, a communication bus and controller, such as a USB controller and USB bus, a network interface, or any other suitable type of connection.

The computing device 1500 further includes a memory device 614 that stores one or more functional modules 620 for performing the operations described above. Alternatively, or in addition, some of the operations described above may be performed by other devices connected to the network, such as the network 50 of the system 10 of FIG. 1, for example. The computing device 1500 may communicate with other devices connected to the network to facilitate performance of some of these operations. For example, the computing device 1500 may communicate and coordinate with certain displays to identify elements of a race being displayed by a particular display.

The memory device 614 may store program code and instructions, executable by the processor circuit 610, to control the computing device 1500. The memory device 614 may include random access memory (RAM), which can include non-volatile RAM (NVRAM), magnetic RAM (ARAM), ferroelectric RAM (FeRAM) and other forms as commonly understood in the gaming industry. In some embodiments, the memory device 614 may include read only memory (ROM). In some embodiments, the memory device 614 may include flash memory and/or EEPROM (electrically erasable programmable read only memory). Any other suitable magnetic, optical and/or semiconductor memory may operate in conjunction with the gaming device disclosed herein.

The computing device 1500 may include a communication adapter 626 that enables the computing device 1500 to communicate with remote devices, such as the wireless network, another computing device 1500, and/or a wireless access point, over a wired and/or wireless communication network, such as a local area network (LAN), wide area network (WAN), cellular communication network, or other data communication network, e.g., the network 50 of FIG. 1.

The computing device 1500 may include one or more internal or external communication ports that enable the processor circuit 610 to communicate with and to operate with internal or external peripheral devices, such as a sound card 628 and speakers 630, video controllers 632, a primary display 634, a secondary display 636, input buttons 638 or other devices such as switches, keyboards, pointer devices, and/or keypads, a touch screen controller 640, a card reader 642, currency acceptors and/or dispensers, cameras, sensors such as motion sensors, mass storage devices, microphones, haptic feedback devices, and/or wireless communication devices. In some embodiments, internal or external peripheral devices may communicate with the processor through a universal serial bus (USB) hub (not shown) connected to the processor circuit 610. Although illustrated as being integrated with the computing device 1500, any of the components therein may be external to the computing device 1500 and may be communicatively coupled thereto. Although not illustrated, the computing device 1500 may further include a rechargeable and/or replaceable power device and/or power connection to a main power supply, such as a building power supply.

In some embodiments, the computing device 1500 may include a head mounted device (HMD) and may include optional wearable add-ons that include one or more sensors and/or actuators. Including ones of those discussed herein. The computing device 1500 may be a head-mounted mixed-reality device configured to provide mixed reality elements as part of a real-world scene being viewed by the user wearing the computing device 1500.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A gaming system comprising:
a processor circuit;
a memory coupled to the processor circuit, the memory comprising machine-readable instructions that, when executed by the processor circuit, cause the processor circuit to:
receive a plurality of wagers from a plurality of skill-based game players to play a skill-based game against one another;
determine a net award amount that is based on the plurality of wagers, wherein the net award amount is awarded to the plurality of skill-based game players;
after the skill-based game is complete, analyze game performance of the plurality of skill-based game players to determine a plurality of optimality values corresponding to the plurality of skill-based game players; and
based on the plurality of optimality values and an outcome of the skill-based game, determine portions of the net award amount to be awarded to the plurality of skill-based game players.

2. The gaming system of claim 1,
wherein the plurality of skill-based game players comprises a first player and a second player,
wherein the processor circuit to determine the portions of the net award amount is further caused to:
determine an outcome of the skill-based game to determine that the first player has won the skill-based game and the second player has lost the skill-based game,
wherein the portions of the net award amount comprise a first percentage of the net award amount and a second percentage of the net award amount,
wherein the first percentage of the net award amount corresponds to the first player and the second percentage comprises a remaining portion of the net award amount is calculated, and
wherein the plurality of optimality values comprises a first optimality value corresponding to the first player and a second optimality value corresponding to the second player.

3. The gaming system of claim 2, wherein responsive to the second optimality value being greater than the first optimality value, determining that the first percentage of the net award amount is 100 percent.

4. The gaming system of claim 2, wherein a minimum of the first percentage of the net award amount is 50 percent based on the first player winning the skill-based game.

5. The gaming system of claim 2, wherein the first percentage of the net award amount is determined based on a formula:
Max(50%,(100%−Max(0,(first optimality value−second optimality value))).

6. The gaming system of claim 1,
wherein the plurality of skill-based game players comprises a first player and a second player,
wherein the portions of the net award amount comprise a first percentage of the net award amount and a second percentage of the net award amount,
wherein, responsive to a draw result in which none of the first player or the second player is determined to win, the first percentage of the net award amount and the second percentage of the net award amount are equal.

7. The gaming system of claim 1,
wherein the plurality of skill-based game players comprises a first player and a second player,
wherein the plurality of optimality values comprises a first optimality value corresponding to the first player and a second optimality value corresponding to the second player,
wherein the portions of the net award amount comprise a first percentage of the net award amount and a second percentage of the net award amount,
wherein, responsive to a draw result in which none of the first player or the second player is determined to win, the first percentage of the net award amount and the second percentage of the net award amount are based on a difference between the first optimality value the second optimality value.

8. The gaming system of claim 1 wherein to determine the net award amount that is based on the plurality of wagers comprise to determine a sum of the plurality of wagers and subtracting a casino fee from the sum of the plurality of wagers to determine the net award amount.

9. The gaming system of claim 1, wherein the skill-based game comprises a perfect knowledge game in which each of the plurality of skill-based game players know a full state of the game.

10. The gaming system of claim 1, wherein the skill-based game comprises an imperfect knowledge game in which each of the plurality of skill-based game players knows less than a full state of the game.

11. The gaming system of claim 1, wherein determining the plurality of optimality values is performed based exclusively on player performance in the skill-based game.

12. The gaming system of claim 1, wherein the game performance comprises a plurality of game actions taken during play of the skill-based game,
wherein determining the plurality of optimality values is performed based on weighting game actions that are recent at a higher value than game actions that occurred prior to recent game actions.

13. The gaming system of claim 1, wherein determining the plurality of optimality values is performed based on game performance that occurred in skill-based games that previously occurred relative to the skill-based game.

14. The gaming system of claim 1, further comprising:
a database that is configured to store optimality data corresponding to the plurality of skill-based game players; and
an authentication interface that is configured to receive an authentication input corresponding to one of the plurality of skill-based game players,
wherein responsive to the receiving the authenticating input, the database generates an average optimality value corresponding to the one of the plurality of skill-based game players, and
wherein the processor circuit is configured to cause the average optimality value to be displayed on a display device.

15. A computer-implemented method of operating a gaming device, the method comprising:
receiving a first wager from a first player of a skill-based game and a second wager from a second player of the skill-based game, wherein the skill-based game comprises the first player playing against the second player;
determining a net award amount as a sum of the first wager and the second wager minus a casino fee;
storing game action data corresponding to a plurality of game actions by the first player and the second player taken during play of the skill-based game;
analyzing, based on the game action data, game performance of each of the first player and the second player;
determining, based on the analyzing, a first optimality value that represents a skill level of the first player and a second optimality value that represents a skill level of the second player; and
based on an outcome of the skill-based game, the first optimality value and the second optimality value, awarding a first portion of the net award amount to the first player and a second portion of the net award amount to be awarded to the second player.

16. The computer-implemented method of claim 15,
wherein responsive to the second optimality value being greater than the first optimality value, determining that the first portion of the net award amount is 100 percent.

17. The computer-implemented method of claim 15, wherein a minimum of the first portion of the net award amount is 50 percent based on the first player winning the skill-based game.

18. The computer-implemented method of claim 15, wherein the first portion of the net award amount is determined based on a formula:
Max(50%,(100%−Max(0,(first optimality value−second optimality value))).

19. The computer-implemented method of claim 15, wherein determining the first optimality value and the second optimality value based on weighting ones of the plurality of game actions that are recent at a higher value than ones of the plurality of game actions that occurred prior to recent game actions.

20. A gaming device comprising:
a display device;
a processor circuit; and
a memory coupled to the processor circuit, the memory comprising machine-readable instructions that, when executed by the processor circuit, cause the processor circuit to:
receive a plurality of wagers from a plurality of players of a skill-based game, wherein the skill-based game provides that the plurality of players are playing against each other;
determine a net award amount that is a sum of the plurality of wagers minus a casino fee;
analyze game performance of each of the plurality of players to determine a plurality of optimality values corresponding to skill levels of each of the plurality of players;
display the plurality of optimality values on the display device during the skill-based game;
determine a plurality of portions of the net award amount to award to the plurality of players based on an outcome of the skill-based game and the plurality of optimality values; and
award the plurality of portions of the net award amount to respective ones of the plurality of players.
